(19) United States
(12) Patent Application Publication
(10) Pub. No.: US 2006/0250753 A1
(43) Pub. Date: Nov. 9, 2006

(54) Elliptic-track treadmill with adjustable travel

(76) Inventors: Pao-Pao Lui, Kang Shan Township (TW); Hung Sheng Wu, Kaohsiung City (TW); Chiu-Chieh Chen, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/896,982

(22) Filed: Jul. 23, 2004

(30) Foreign Application Priority Data
Jul. 25, 2003 (TW) 92213671

(51) Int. Cl. H02B 1/00

(52) U.S. Cl. 361/600

(57) ABSTRACT

An elliptic-track treadmill with adjustable travel, including: a bed placed on the ground, an upright stem upward extending from one end of the bed; a transmission unit mounted on the upright stem; and a linking mechanism drivable by the transmission unit to drive two pedals to move in an elliptic track. The linking mechanism includes a pair of cranks drivable by the transmission unit. One end of each crank is pivotally connected with one end of an adjustment member. The adjustment member has an axially telescopic free end pivotally connected with the crank. The free end is connected with the pedal. The other end of the adjustment member is pivotally connected with one end of a link. The other end of the link is pivotally connected with each side of top end of the upright stem of the bed.

### BACKGROUND OF THE INVENTION

The present invention is related to an elliptic-track treadmill with adjustable travel, and more particularly to an elliptic-track treadmill which transmits power by means of a four-like mechanism. In addition, the elliptic track and travel of the pedals of the elliptic-track treadmill are adjustable.

In a conventional elliptic track-treadmill, the track and travel of the pedals is fixed and cannot be adjusted in accordance with the height and configuration of different users. This often leads to inconvenience to a user in exercise.

FIG. 7 shows an elliptic-track treadmill in which the elliptic track and travel of the pedals are adjustable. The elliptic-track treadmill includes a bed 6 rested on the ground, an upright stem 61 disposed at front end of the bed 6 and a transmission unit 7 disposed at rear end of the bed 6. The transmission unit 7 has a transmission wheel 71 and two links 72 respectively pivotally connected with two sides of the transmission wheel 71. Two rock arms 64 are respectively pivotally connected with two sides of the stem 61. Each rock arm 64 has a downward extending rocking end 641 which can swing back and forth. The rocking end 641 has several shafted sections 642 vertically arranged at equal intervals. Each link 72 is pivotally connected with a pedal shaft 8 which is pivotally connected with the rock arm 64. The middle section of the pedal shaft 8 is formed with a rail 81 in which a pedal 82 is slidably mounted. Each pedal 82 is pivotally connected with a swinging arm 83 which is pivotally connected with one of the shafted sections 642 of the rock arm 64.

According to the above arrangement, the transmission wheel 71 of the transmission unit 7 drives the links 72 to rotate. The two links 72 respectively drive the pivoted ends of the pedal shafts 8 to revolve. Accordingly, the pedals 82 on the pedal shafts 8 are moved in an elliptic path. When adjusting the distance between the pedals 82 so as to adjust the elliptic track and travel, as shown in FIG. 8, the swinging arms 83 on outer sides of the pedals 82 are pivotally connected with another shafted section 642 of the rock arms 64. Therefore, the positions of the pedals 82 on the pedal shafts 8 are changed so as to adjust the elliptic track and travel of the pedals 82.

When adjusting elliptic track and travel of the pedals 82, a user must manually pivotally connect the swinging arm 83 with another shafted section 642 of the rock arm 64. Accordingly, in the case that when exercising, the user finds the elliptic track and travel of the pedals 82 are too short to tread, it is necessary for the user to first step down from the treadmill and then laboriously detach the swinging arms 83 from the shafted sections 642 of the rock arms 64. Thereafter, the user needs to select another shafted section 642 of the rock arm 64 and pivotally connect the swinging arm 83 with the shafted section 642. In the case that after adjusted, the user finds that the distance between the pedals 82 its still unsuitable, the user will have to readjust the elliptic track and travel of the pedals 82. Therefore, it is quite troublesome and inconvenient to adjust the elliptic track and travel of the pedals 82.

Taiwanese Patent Publication No. 499973 discloses an elliptic-track treadmill in which the travel can be electrically adjusted to eliminate the above problems. Such elliptic-track treadmill has a crank composed of a main crank and a subsidiary crank. An electric telescopic mechanism is disposed between the main and subsidiary cranks for adjusting the length of the crank so as to adjust the elliptic track and travel of the pedals.

The elliptic track and travel of the pedals of the above elliptic-track treadmill can be electrically adjusted. However, the crank is directly designed with telescopic mechanism. It is hard for the crank to drive the slide bar to rotate, especially after the crank is extended and the distance between the crank and the rotary shaft is elongated.

Therefore, it is tried by the applicant to develop an improved elliptic-track treadmill to solve the above problems existing the prior art.

### SUMMARY OF THE INVENTION

It is therefore a primary object of the present invention to provide an elliptic-track treadmill with adjustable travel. The treadmill includes: a bed placed on the ground, an upright stem upward extending from one end of the bed; a transmission unit mounted on the upright stem; and a linking mechanism drivable by the transmission unit to drive two pedals to move in an elliptic track. The linking mechanism includes a pair of cranks drivable by the transmission unit. One end of each crank is pivotally connected with one end of an axially telescopic adjustment member. The adjustment member has an axially telescopic free end pivotally connected with the crank. The free end is connected with the pedal. The other end of the adjustment member is pivotally connected with one end of a link. The other end of the link is pivotally connected with each side of top end of the upright stem of the bed.

The crank, adjustment member and link of the linking mechanism and the upright stem of the bed form a four-link mechanism so that the power can be truly transmitted to the slide bars of the pedals to smoothly move the pedals in an elliptic track. In addition, the free end of the adjustment member can be axially telescopically moved to adjust the distance between the pedals. In exercise, a user can readily adjust the distance according to the user's own step distance. Therefore, the adjustment can be conveniently performed.

It is a further object of the present invention to provide the above elliptic-track treadmill in which the crank via the adjustment member is connected with the slide bar of the pedal, whereby the adjustment member can adjust the elliptic track and travel of the pedals. Accordingly, the elliptic track and travel of the pedals can be adjusted without changing the length of the crank. Therefore, the crank can drive the slide bar to rotate without applying great force thereon.

The present invention can be best understood through the following description and accompanying drawings wherein:

### BRIEF DESCRIPTION OF THE DRAWINGS

FIG. 1 is a perspective view of the present invention;

FIG. 2 is a side view of the present invention;

FIG. 3 is a side view of the present invention, showing an elliptic track and travel of the pedals before adjusted by the adjustment member;

FIG. 4 is a side view of the present invention, showing an elliptic track and travel of the pedals after adjusted by the adjustment member;

FIG. 5 shows the transmission of the four-link mechanism of the present invention and the adjustment of the elliptic track and travel of the pedals of the present invention;

FIG. 6 shows a second embodiment of the present invention;

FIG. 7 is a side view of a conventional elliptic-track treadmill; and

FIG. 8 is a side view of the conventional elliptic-track treadmill, in which the travel has been adjusted.

### DETAILED DESCRIPTION OF THE PREFERRED EMBODIMENTS

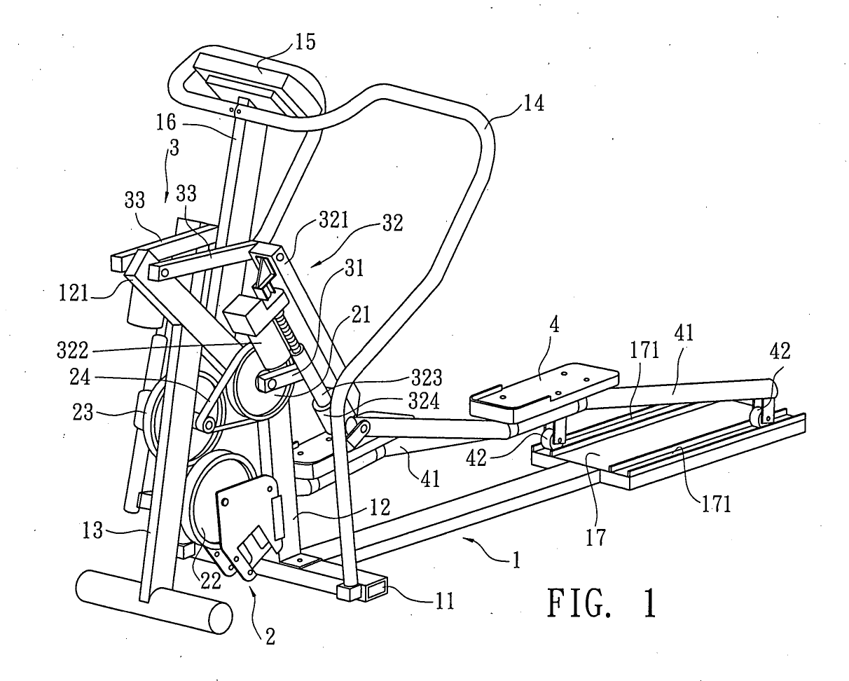

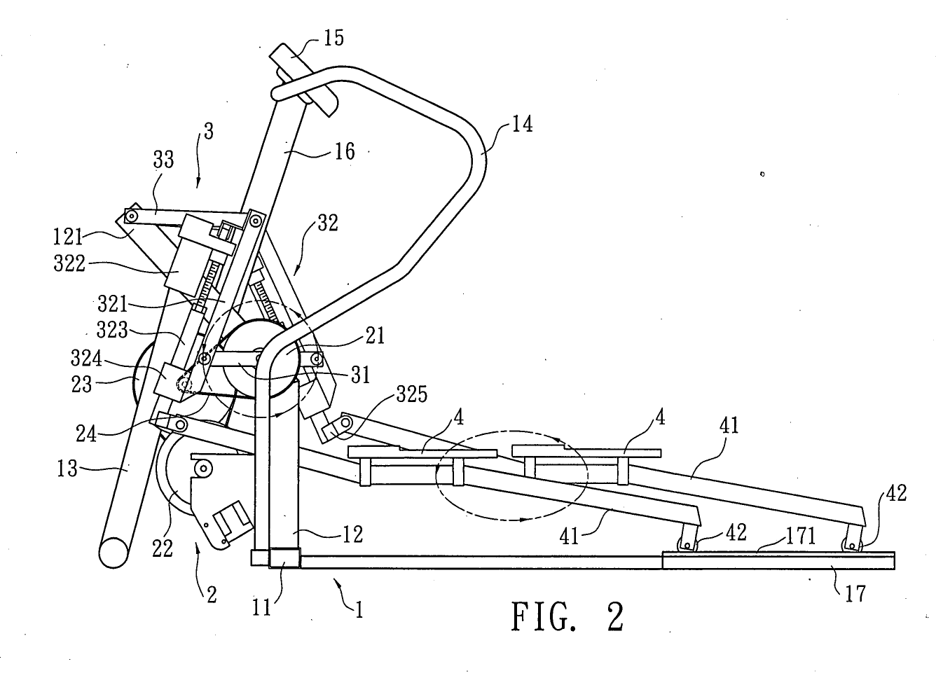

Please refer to FIGS. 1 and 2. The elliptic-track treadmill with adjustable travel of the present invention includes a bed 1 placed on the ground, a transmission unit 2 mounted in the bed 1 and a linking mechanism 3 driven by the transmission unit 2. The linking mechanism 3 serves to drive two pedals 4 to move in elliptic track.

The bed 1 has a transverse beam 11 at front end for supporting the front end of the bed 1 on the ground. An upright stem 12 upward extends from middle section of the transverse beam 11. The upright stem 12 has an upper extending section 121 which is forward inclined. A front bar 13 downward extends from the bottom of the extending section 121 to help in supporting the front end of the bed 1 on the ground. Two rails 14 respectively upward extend from two ends of the transverse beam 11 of the bed 1. A panel 15 is disposed between the rails 14. A supporting bar 16 is fixedly connected between the bottom of the panel 15 and the extending section 121 of the upright stem 12 for supporting the rails 14 and the panel 15. A rear end of the bed 1 has a board body 17 for supporting the rear end of the bed 1 on the ground. Two guide channels 171 are respectively formed on two longitudinal sides of top face of the board body 17.

The transmission unit 2 includes a driving wheel 21 for driving the linking mechanism 3 to drive the pedals 4. In this embodiment, an inertial wheel 22 via a driven wheel 23 drives the driving wheel 21 to rotate. The driving wheel 21 is pivotally disposed on one side of the extending section 121 of the upright stem 12. The inertial wheel 22 is pivotally disposed on front side of the upright stem 12 near the transverse beam 11. The driven wheel 23 is pivotally disposed on inner side of middle section of the front bar 13 of the bed 1. The driving wheel 21 is linked with the driven wheel 23 via a belt 24 and the driven wheel 23 is linked with the inertial wheel 22 via a belt 24.

The linking mechanism 3 includes a pair of cranks 31 drivable by the transmission unit 2. One end of each crank 31 is fixedly connected with the shaft of each side of the driving wheel 21, whereby the driving wheel 21 can drive the cranks 31 to rotate. The other end of the crank 31 is pivotally connected with one end of an adjustment member 32. The other end of the adjustment member 32 is pivotally connected with one end of a link 33. The other end of the link 33 is pivotally connected with each side of top end of the extending section 121 of the upright stem 12. In this embodiment, the adjustment member 32 has a linking bar 321 and a telescopic rod 323 disposed under the linking bar 321 and drivable by a reducing motor 322. The telescopic rod 323 has an axially telescopic free end 325. One end of the linking bar 321 is pivotally connected with the link 33, while the other end of the linking bar 321 is pivotally connected with the crank 31. A slide sleeve 324 is disposed under the end of the linking bar 321, which is pivotally connected with the crank 31. The free end 325 of the telescopic rod 323 is slidably fitted in the slide sleeve 324. By means of the driving of the reducing motor 322, the free end 325 of the telescopic rod 323 can be telescopically moved within the slide sleeve 324.

Each pedal 4 is fixed on a middle section of a slide bar 41. One end of the slide bar 41 is pivotally connected with the free end 325 of the telescopic rod 323. A slide member 42 is disposed on the other end of the slide bar 41. In this embodiment, the slide member 42 is a roller slidably disposed in the guide channel 171 of the board body 17.

According to the above arrangement, in use, a user treads the pedals 4 to drive the inertial wheel 22 of the transmission unit 2 to inertially continuously rotate. The inertial wheel 22 further via the driven wheel 23 drives the driving wheel 21 to rotate. At this time, the cranks 31 of the linking mechanism 3 on two sides of the driving wheel 21 are rotated along with the driving wheel 21. Accordingly, the end of the adjustment member 32, which is pivotally connected with the crank 31, is revolved about the shaft of the driving wheel 21. At this time, the end of the slide bar 41 of the pedal 4, which is pivotally connected with the adjustment member 32, is revolved. The slide member 42 of the other end of the slide bar 41 is back and forth slid along the board body 17, whereby the pedals 4 are moved in an elliptic track.

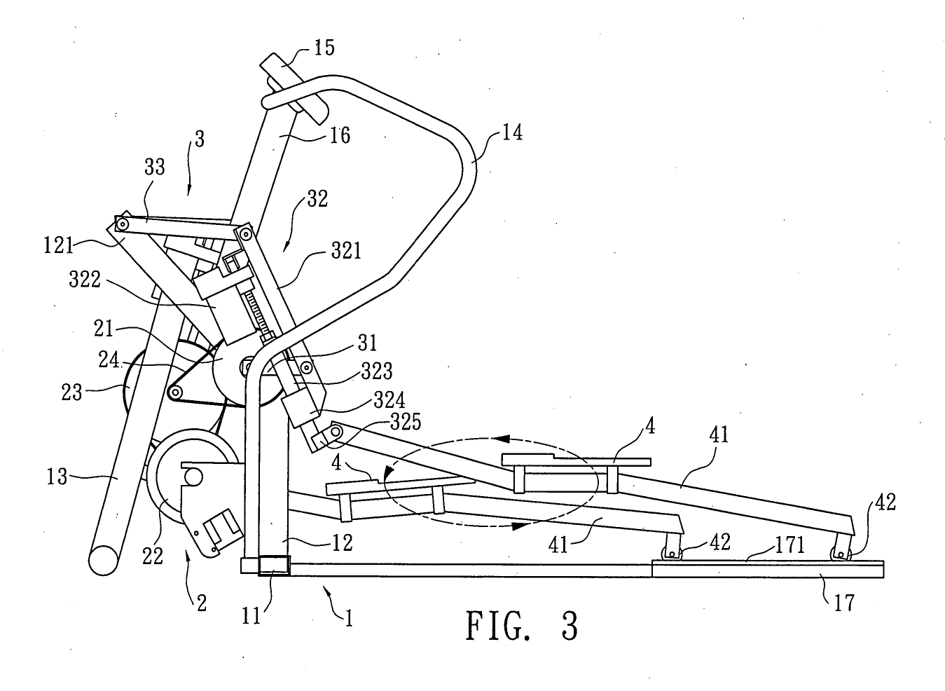

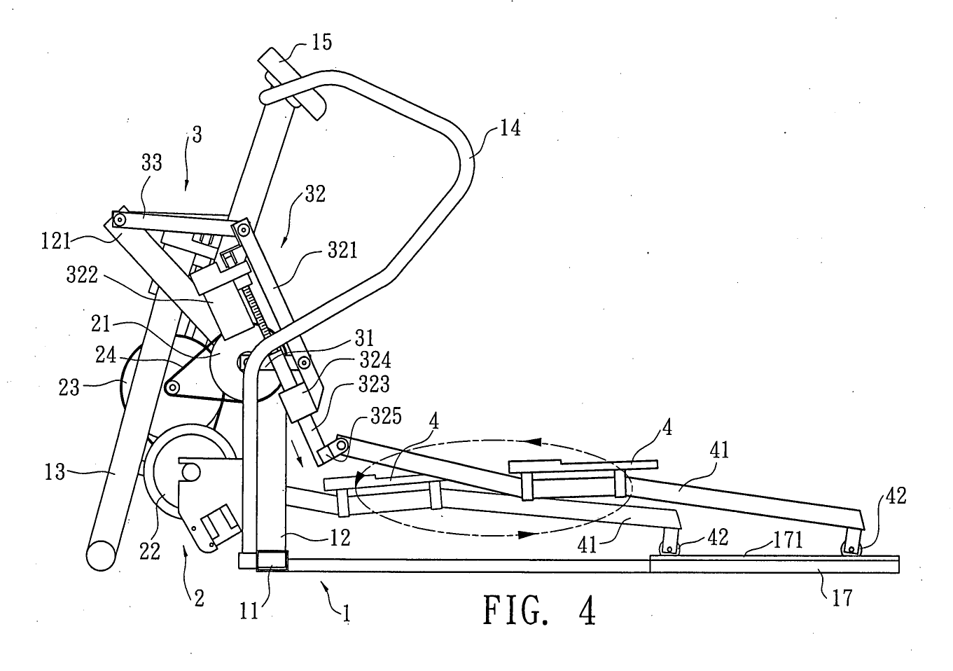

When adjusting the elliptic track and travel of the pedals 4, as shown in FIGS. 3 and 4, the reducing motor 322 drives the telescopic rod 323 to telescopic move within the slide sleeve 324 so as to drive the slide bar 41 to move back and forth and change the distance between the two pedals 4. Accordingly, the elliptic track and travel of the pedals 4 can be adjusted.

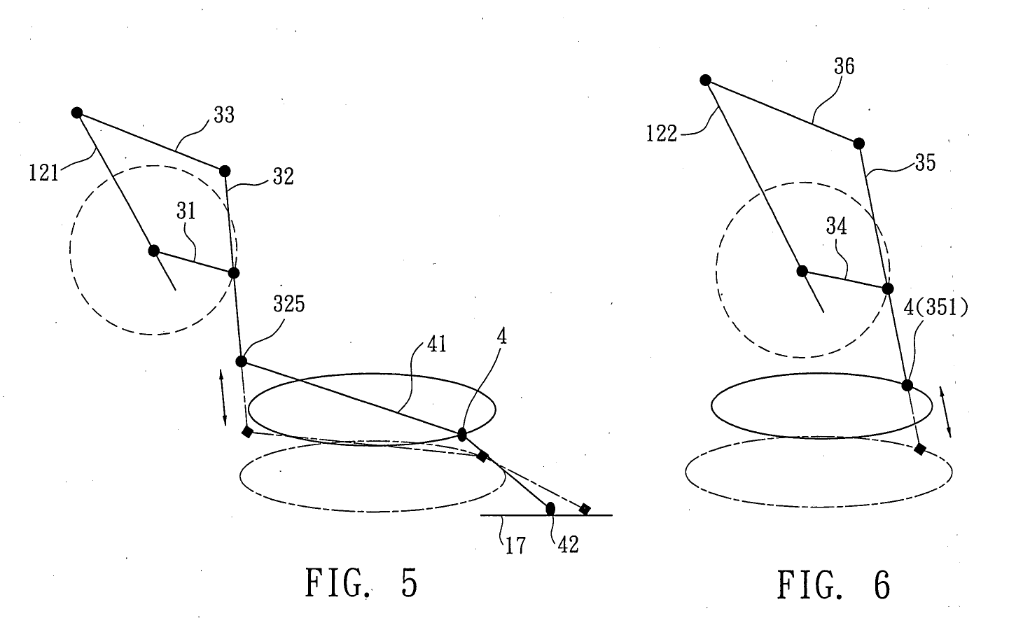

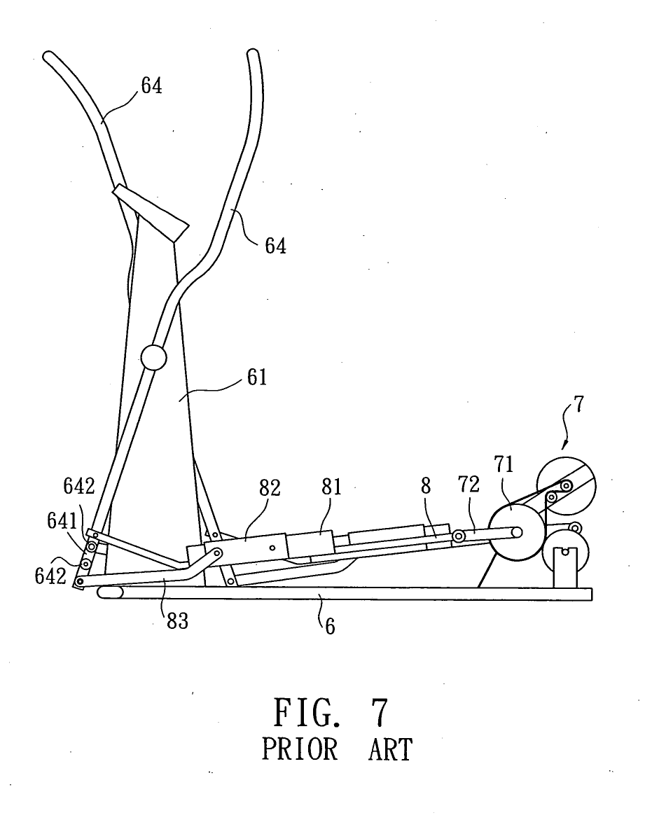

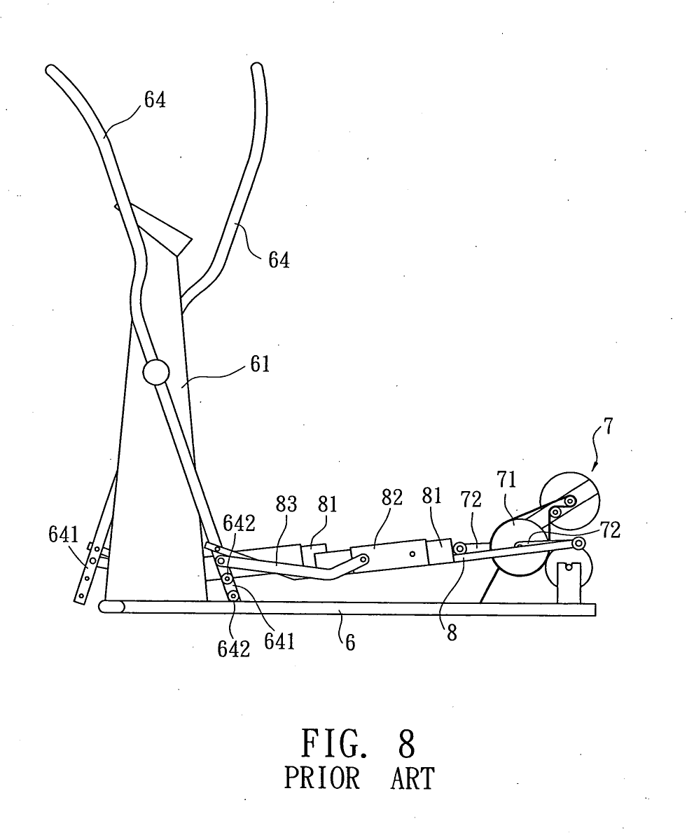

Referring to FIG. 5, the crank 31, adjustment member 32 and link 33 of the linking mechanism 3 and the extending section 121 of the upright stem 12 of the bed 1 form a four-link mechanism so that the power can be truly transmitted to the slide bars 41 of the pedals 4 to smoothly move the pedals 4 in an elliptic track. Moreover, the telescopic rod 323 is driven by the reducing motor 322 to electrically adjust the distance between the pedals 4. In exercise, a user can readily adjust the distance according to the user's own step distance. Therefore, the adjustment can be conveniently performed.

Furthermore, the crank 31 via the adjustment member 32 is connected with the slide bar 41 of the pedal 4, whereby the adjustment member 32 can adjust the elliptic track and travel of the pedals 4. Accordingly, the elliptic track and travel of the pedals 4 can be adjusted without changing the length of the crank 31. Therefore, the crank 31 can drive the slide bar 41 to rotate without applying great force thereon.

FIG. 6 shows a second embodiment of the present invention, in which the linking mechanism 3 is applied to an elliptic-track treadmill in which the pedals are free from the slide bars. The linking mechanism 3 includes a pair of cranks 34 drivable by the transmission unit 2. One end of each crank 34 is fixedly connected with the shaft of each side of the driving wheel 21 of the transmission unit 2, whereby the driving wheel 21 can drive the cranks 34 to rotate. The other end of the crank 34 is pivotally connected with one end of an adjustment member 35. The other end of the adjustment member 35 is pivotally connected with one end of a link 36. The other end of the link 36 is pivotally connected with each side of top end of the extending section 122 of the upright stem 12. The adjustment member 35 has an axially telescopic free end 351 connected with the pedal 4.

The crank 34, adjustment member 35 and link 36 of the linking mechanism 3 and the extending section 122 of the upright stem 12 of the bed 1 form a four-link mechanism so that the power can be truly transmitted to the slide bars 41 of the pedals 4 to smoothly move the pedals 4 in an elliptic track. In addition, the free end 351 of the adjustment member 35 can be axially telescopically moved to change the position of the pedals 4 so as to adjust the elliptic track thereof.

The above embodiments are only used to illustrate the present invention, not intended to limit the scope thereof. Many modifications of the above embodiments can be made without departing from the spirit of the present invention.

What is claimed is:

1. An elliptic-track treadmill with adjustable travel, comprising:
a bed placed on the ground, an upright stem upward extending from one end of the bed;
a transmission unit mounted on the upright stem; and
a linking mechanism drivable by the transmission unit, the linking mechanism serving to drive two pedals to move in an elliptic track, the linking mechanism including a pair of cranks drivable by the transmission unit, one end of each crank being pivotally connected with one end of an axially telescopic adjustment member, the adjustment member having an axially telescopic free end pivotally connected with the crank, the free end being connected with the pedal, the other end of the adjustment member being pivotally connected with one end of a link, the other end of the link being pivotally connected with each side of top end of the upright stem of the bed.

2. The elliptic-track treadmill with adjustable travel as claimed in claim 1, wherein the bed has a transverse beam at front end for supporting the front end of the bed on the ground, the upright stem upward extending from middle section of the transverse beam, the upright stem having an upper extending section which is forward inclined, the links of the linking mechanism being respectively pivotally connected with two sides of the top end of the extending section, a front bar downward extending from the bottom of the extending section to help in supporting the front end of the bed on the ground, the transmission unit being disposed between the upright stem and the front bar, two rails respectively upward extending from two ends of the transverse beam of the bed, a panel being disposed between the rails, a supporting bar being fixedly connected between the bottom of the panel and the extending section of the upright stem for supporting the rails and the panel, a rear end of the bed having a board body for supporting the rear end of the bed on the ground, two guide channels being respectively formed on two longitudinal sides of top face of the board body, each pedal being fixed on a middle section of a slide bar, one end of the slide bar being pivotally connected with the free end of the adjustment member, a slide member being disposed on the other end of the slide bar, the slide members being respectively slidably disposed in the guide channels of the top face of the board body.

3. The elliptic-track treadmill with adjustable travel as claimed in claim 2, wherein the adjustment member of the linking mechanism has a linking bar and a telescopic rod disposed on one side of the linking bar and drivable by a reducing motor, the telescopic rod having the axially telescopic free end, one end of the linking bar being pivotally connected with the link, while the other end of the linking bar being pivotally connected with the crank, a slide sleeve being disposed under the end of the linking bar, which is pivotally connected with the crank, the free end of the telescopic rod being slidably fitted in the slide sleeve, the free end of the telescopic rod being pivotally connected with the slide bar of each pedal.

4. The elliptic-track treadmill with adjustable travel as claimed in claim 2, wherein the transmission unit includes a driving wheel for driving the crank of the linking mechanism to rotate, an inertial wheel via a driven wheel driving the driving wheel to rotate, the driving wheel being pivotally disposed on one side of the extending section of the upright stem, the inertial wheel being pivotally disposed on front side of the upright stem near the transverse beam, the driven wheel being pivotally disposed on inner side of middle section of the front bar of the bed, the driving wheel being linked with the driven wheel via a belt and the driven wheel being linked with the inertial wheel via a belt.

5. The elliptic-track treadmill with adjustable travel as claimed in claim 2, wherein the slide member of the slide bar of each pedal is a roller.
